(19) United States
(12) Patent Application Publication
(10) Pub. No.: US 2021/0136135 A1
(43) Pub. Date: May 6, 2021

(54) IMAGE STABILIZATION CUES FOR ACCESSIBLE GAME STREAM VIEWING

(71) Applicant: Sony Interactive Entertainment Inc., Tokyo (JP)

(72) Inventor: STEVEN OSMAN, San Mateo, CA (US)

(21) Appl. No.: 16/670,353

(22) Filed: Oct. 31, 2019

(51) Int. Cl. H04L 29/06; A63F 13/86

(52) U.S. Cl. CPC H04L 65/604; A63F 13/86; H04L 65/4076

(57) ABSTRACT

A component such as a streaming gaming service creates two streams, a first stream for people with accessibility requirements and a second stream without. If desired, to reduce the number of streams that must be generated, the first stream may be rendered in an “everything on” mode in which motion stabilization is implemented on the video to reduce the perception of camera shakiness, and the second stream may be rendered in a “player's choice” mode without motion stabilization. Alternatively, metadata of the video can indicate whether and what accessibility features should be applied on the receiver end.

### FIELD

The present application relates to technically inventive, non-routine solutions that are necessarily rooted in computer technology and that produce concrete technical improvements.

### BACKGROUND

As recognized herein, in considering the accessibility needs of players, the needs of other people watching the streams on a web service should be considered. Present principles understand that real or emulated camera shakiness can cause motion sickness in certain populations when viewing video produced by such a shaky camera. While some computer simulations such as some computer games (e.g., “God of War”) have features to reduce the shakiness, viewers of twitch streams are subject to the choices of the player, which may result in discomfort for certain other viewers.

There are currently no adequate solutions to the foregoing computer-related, technological problem.

### SUMMARY

Accordingly, a component such as a streaming gaming service creates two streams, a first stream for people with accessibility requirements and a second stream without. If desired, to reduce the number of streams that must be generated, the first stream may be rendered in an “everything on” mode and the second stream may be rendered in a “player's choice” mode, so that only two selections may be provided.

Alternatively, metadata may be coupled to the video, either through an auxiliary stream in the video, or in just a very small set of data emitted as the last row or column in the image. This metadata may include a vector that indicates the motion of the camera due to shake and other things, so as to facilitate image stabilization. It may also include text cues and other information similar to closed captions, as well as color-related information, for instance, providing a small remap table for colors so that good quality re-rendering for color blind people is facilitated. The metadata also may indicate touch and sound associated with the video. Haptic sensations may be modified according to the user's preference. Sound sources may be visualized where they are critical, for instance, for sound-based puzzles for which hearing impaired people need visual cues.

Accordingly, in a first aspect a device includes at least one processor and at least one computer memory that is not a transitory signal and that in turn includes instructions executable by the processor to receive selection of one of two options, a first one of the options being motion stabilization of a first stream and a second one of the options being no motion stabilization of the first stream. The instructions are executable to provide the first stream to a viewer system according to the selection.

In some embodiments, two and only two options to provide to the viewer system are available. In other embodiments more than two options are available to provide to the viewer system, with each option being characterized by a respective motion stabilization amount or other accessibility option different from motion stabilization amounts of other options.

In some implementations, the device is implemented by a stream source, and the device further includes the viewer system. In such implementations, the viewer system can be configured with instructions to present on a display a user interface (UI) with at least two selectors selectable to input the selection to the source. The stream provided to the player may be stabilized in six degrees of freedom.

In another aspect, an apparatus includes at least one computer readable storage medium that is not a transitory signal and that includes instructions executable by at least one processor to receive at least one stream composed of video and/or a computer simulation. The instructions are executable to receive metadata along with the stream, and to present the stream with at least one accessibility feature according to the metadata.

In examples, the metadata includes information pertaining to motion stabilization of the stream, at least one vector that indicates motion of a camera, information pertaining to re-coloring the stream, information pertaining to altering text in the stream, and or any combination thereof.

The metadata may be contained in an auxiliary stream separate from the stream or it may be contained in the stream itself. The apparatus may be implemented in a viewer system configured for receiving the stream.

In another aspect, a device includes at least one processor and at least one computer memory that is not a transitory signal and that in turn includes instructions executable by the processor to receive selection of one of two options. A first one of the options is at least one accessibility feature of a first stream and a second one of the options is no accessibility feature of the first stream. The first stream is provided to a viewer system according to the selection.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a schematic diagram illustrating an implementation consistent with present principles;

FIGS. 2A and 2B are schematic diagrams illustrating a technique of motion stabilization;

FIG. 3 is a screen shot of an example user interface (UI) consistent with present principles;

FIG. 4 is a block diagram of an alternate implementation consistent with present principles;

FIG. 5 is a flow chart of example logic consistent with FIG. 2;

FIG. 6 is a flow chart of example logic consistent with FIG. 4;

FIG. 7 is a screen shot of an example UI for inputting user preference for motion stabilization to support the logic of FIG. 6; and

FIGS. 8 and 9 are flow charts of example logic pertaining to legacy computer simulations.

### DETAILED DESCRIPTION

This disclosure relates generally to computer ecosystems including aspects of computer networks that may include consumer electronics (CE) devices. A system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access websites hosted by the Internet servers discussed below.

Servers and/or gateways may include one or more processors executing instructions that configure the servers to receive and transmit data over a network such as the Internet. Or, a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security.

As used herein, instructions refer to computer-implemented steps for processing information in the system. Instructions can be implemented in software, firmware or hardware and include any type of programmed step undertaken by components of the system.

A processor may be any conventional general-purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library. While flow chart format may be used, it is to be understood that software may be implemented as a state machine or other logical method.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

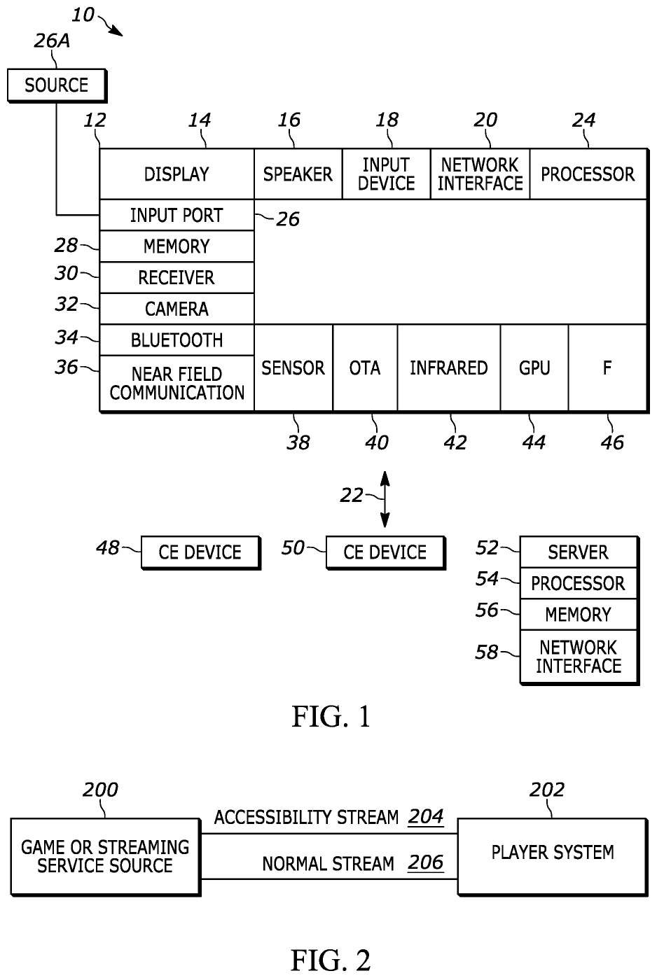

Now specifically referring to FIG. 1, an example system 10 is shown, which may include one or more of the example devices mentioned above and described further below in accordance with present principles. Note that computerized devices described in all of the figures herein may include some or all of the components set forth for various devices in FIG. 1.

The first of the example devices included in the system 10 is a consumer electronics (CE) device configured as an example primary display device, and in the embodiment shown is an audio video display device (AVDD) 12 such as but not limited to an Internet-enabled TV with a TV tuner (equivalently, set top box controlling a TV). The AVDD 12 may be an Android®-based system. The AVDD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVDD 12 and/or other computers described herein is configured to undertake present principles (e.g. communicate with other CE devices to undertake present principles, execute the logic described herein, and perform any other functions and/or operations described herein).

Accordingly, to undertake such principles the AVDD 12 can be established by some or all of the components shown in FIG. 1. For example, the AVDD 12 can include one or more displays 14 that may be implemented by a high definition or ultra-high definition “4K” or higher flat screen and that may or may not be touch-enabled for receiving user input signals via touches on the display. The AVDD 12 may also include one or more speakers 16 for outputting audio in accordance with present principles, and at least one additional input device 18 such as e.g. an audio receiver/microphone for e.g. entering audible commands to the AVDD 12 to control the AVDD 12. The example AVDD 12 may further include one or more network interfaces 20 for communication over at least one network 22 such as the Internet, an WAN, an LAN, a PAN etc. under control of one or more processors 24. Thus, the interface 20 may be, without limitation, a Wi-Fi transceiver, which is an example of a wireless computer network interface, such as but not limited to a mesh network transceiver. The interface 20 may be, without limitation a Bluetooth transceiver, Zigbee transceiver, IrDA transceiver, Wireless USB transceiver, wired USB, wired LAN, Powerline or MoCA. It is to be understood that the processor 24 controls the AVDD 12 to undertake present principles, including the other elements of the AVDD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVDD 12 may also include one or more input ports 26 such as, e.g., a high definition multimedia interface (HDMI) port or a USB port to physically connect (e.g. using a wired connection) to another CE device and/or a headphone port to connect headphones to the AVDD 12 for presentation of audio from the AVDD 12 to a user through the headphones. For example, the input port 26 may be connected via wire or wirelessly to a cable or satellite source 26a of audio video content. Thus, the source 26a may be, e.g., a separate or integrated set top box, or a satellite receiver. Or, the source 26a may be a game console or disk player.

The AVDD 12 may further include one or more computer memories 28 such as disk-based or solid-state storage that are not transitory signals, in some cases embodied in the chassis of the AVDD as standalone devices or as a personal video recording device (PVR) or video disk player either internal or external to the chassis of the AVDD for playing back AV programs or as removable memory media. Also, in some embodiments, the AVDD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVDD 12 is disposed in conjunction with the processor 24. However, it is to be understood that that another suitable position receiver other than a cellphone receiver, GPS receiver and/or altimeter may be used in accordance with present principles to e.g. determine the location of the AVDD 12 in e.g. all three dimensions.

Continuing the description of the AVDD 12, in some embodiments the AVDD 12 may include one or more cameras 32 that may be, e.g., a thermal imaging camera, a digital camera such as a webcam, and/or a camera integrated into the AVDD 12 and controllable by the processor 24 to gather pictures/images and/or video in accordance with present principles. Also included on the AVDD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVDD 12 may include one or more auxiliary sensors 38 (e.g., a motion sensor such as an accelerometer, gyroscope, cyclometer, or a magnetic sensor, an infrared (IR) sensor for receiving IR commands from a remote control, an optical sensor, a speed and/or cadence sensor, a gesture sensor (e.g. for sensing gesture command), etc.) providing input to the processor 24. The AVDD 12 may include an over-the-air TV broadcast port 40 for receiving OTA TV broadcasts providing input to the processor 24. In addition to the foregoing, it is noted that the AVDD 12 may also include an infrared (IR) transmitter and/or IR receiver and/or IR transceiver 42 such as an IR data association (IRDA) device. A battery (not shown) may be provided for powering the AVDD 12.

Still further, in some embodiments the AVDD 12 may include a graphics processing unit (GPU) 44 and/or a field-programmable gate array (FPGA) 46. The GPU and/or FPGA may be utilized by the AVDD 12 for, e.g., artificial intelligence processing such as training neural networks and performing the operations (e.g., inferences) of neural networks in accordance with present principles. However, note that the processor 24 may also be used for artificial intelligence processing such as where the processor 24 might be a central processing unit (CPU).

Still referring to FIG. 1, in addition to the AVDD 12, the system 10 may include one or more other computer device types that may include some or all of the components shown for the AVDD 12. In one example, a first device 48 and a second device 50 are shown and may include similar components as some or all of the components of the AVDD 12. Fewer or greater devices may be used than shown.

The system 10 also may include one or more servers 52. A server 52 may include at least one server processor 54, at least one computer memory 56 such as disk-based or solid state storage, and at least one network interface 58 that, under control of the server processor 54, allows for communication with the other devices of FIG. 1 over the network 22, and indeed may facilitate communication between servers, controllers, and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server and may include and perform “cloud” functions such that the devices of the system 10 may access a “cloud” environment via the server 52 in example embodiments. Or, the server 52 may be implemented by a game console or other computer in the same room as the other devices shown in FIG. 1 or nearby.

The devices described below may incorporate some or all of the elements described above.

The methods described herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may be embodied in a non-transitory device such as a CD ROM or Flash drive. The software code instructions may alternatively be embodied in a transitory arrangement such as a radio or optical signal, or via a download over the Internet.

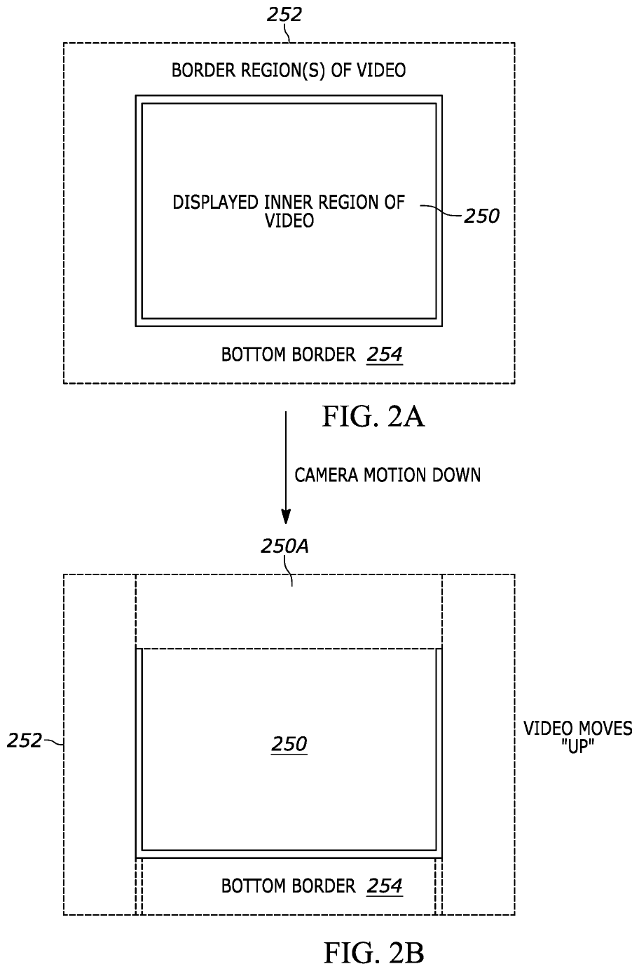

Now referring to FIG. 2, a game or streaming service source 200 is shown for communicating computer simulations or videos (collectively, “streams”) to a player system 202 such as a display, a simulation console communicating with the display, a combination thereof, a head-mounted display (HIVID), etc. As shown in FIG. 2, the source 200 may stream plural versions of the same simulation or video to the system 202 either automatically or one at a time responsive to user selection at the player system 202. In the example shown, an accessibility stream version 204 and a normal stream version 206 can be sent to the player system 202. The difference between the versions 204, 206 is that the normal version contains no accessibility features, whereas the accessibility stream version 204 contains one or more accessibility features as further disclosed herein.

As a first example, the normal version 206 may include video filmed with a real camera while the camera was shaking, or a simulation rendered as if it were imaged by a shaking camera, whereas the accessibility version 204 removes part or all of the camera motion effects in the simulation or video. Without limitation, the accessibility version 204 may be produced by digitally processing the normal version with a warp stabilizer, a stabilize motion feature, or a Reelsteady for After Effects program. Or, the accessibility version 204 may be produced optically, for example by producing video using Sony's FDR-X3000 or HDR-AS300 action cameras. In such a case, a second camera that does not include optical motion stabilization may be used to simultaneously create the normal version 206.

Note that in the accessibility stream 204, only portions of the video image, and not the entire image, may be altered. For example, only critical objects may be altered for accessibility purposes. Critical objects may be identified for enhancement using a heatmap generated from a viewer's or viewers' gaze direction as imaged by a camera on any of the components discussed herein.

Note further that to compensate for camera motion, it may be necessary to initially present only an inner region of the entire video frame and, if necessary, expand that inner region to fill the display, such that unshown regions of the video frame may be made to appear by moving the inner region up or down as appropriate to compensate for motion.

FIGS. 2A and 2B illustrate this, in which initially (FIG. 2A) the inner region 250 of an entire video frame 252 fills the screen as indicated by the double lines. Border regions of the video, including, in the example shown, a bottom border region 254, are not onscreen. In an example in which camera motion is down, to compensate the inner region 250 moves up as shown in FIG. 2B. A top strip 250A of the inner region 250 consequently has moved off screen, while the bottom border region 254 has moved on screen as indicated by the double lines (whether dashed or solid).

Thus, for instance, in a video frame of dimension N×M pixels, the inner (N−x), (M−y) region may be presented and then moved as needed up or down or left or right to compensate for camera motion, with the unshown border regions outside the inner region moving into view as appropriate. Equivalently, video may initially be generated with excessive size such that only the inner region can be fit onto the display, with the existing border regions being moved into view as the inner region is moved to compensate for camera motion.

Or, an inner region of the video image may be shrunk to reduce the effects of camera shaking or movement while the peripheral regions outside the inner region, which may be less affected by camera motion, may be expanded.

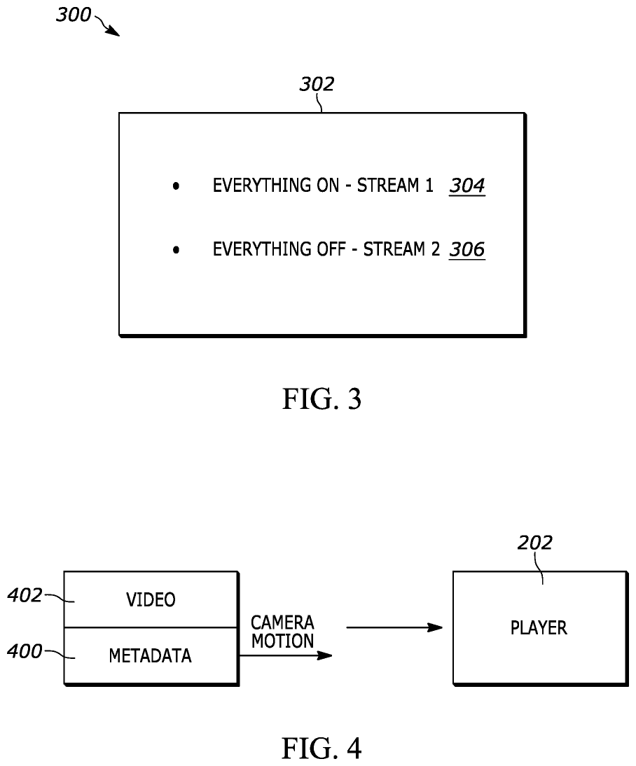

FIG. 3 illustrates a user interface (UI) 300 that may be presented on a display 302 of the player system 202 in FIG. 1. As shown, the UI 300 can include at least two selectors for selecting which stream from the source 200 to view on the display 302 and in the example shown two and only two selectors to reduce the burden of generating a large number of different streams with different degrees of motion stabilization. In the example shown, a first selector 304 may be selected to view the accessibility stream 204 with full motion stabilization, essentially an “everything on” stream in terms of the accessibility stream being stabilized in all six degrees of freedom. The UI 300 also may include a second selector 306 to select the normal stream 206, i.e., no motion stabilization at all. It is to be understood that additional selectors may be provided when additional streams beyond two with degrees of stabilization varying between full and none may be provided.

Alternatively, FIG. 4 shows that metadata 400 may accompany a single video or simulation 402. The metadata 400 may indicate whether the video 402 is motion-stabilized or not. The metadata may be coupled to the video, either through an auxiliary stream in the video, or in just a very small set of data emitted as the last row or column in the image. This metadata may include a vector that indicates the motion of the camera due to shake and other things, so as to facilitate image stabilization by the player system 202. It may also or alternatively include text cues and other information similar to closed captions to increase the contrast of text compared to the video for easier viewing of the text, as well as color-related information, for instance, providing a small remap table for colors so that good quality re-rendering for color blind people is facilitated. Thus, accessibility features in the accessibility stream 204 may include motion stabilization, color re-mapping, text contrast changes, and combinations thereof. When color re-mapping is desired, the palate of the image may be changed to compensate for a particular type of color-blindness. In other words, the histogram of the image may change as appropriate for the color-blindness of the viewer. Note that only key objects in the video frame may be re-colored, and the remaining regions of the video frame may not be re-colored.

The metadata discussed above may indicate not just motion but extremes of motion, to command the playback device, for instance, to expand (or “blow up”) the inner region of the video to compensate for at most e.g. 3% in any direction, resulting in expansion of 6% total to account for the image moving up or down 3%.

As another alternative, additional strips or slivers of video for the top, bottom, left, and right-side portions of the video frames may be transmitted such that extra portions of video are available to work with. Thus, if the camera motion is up, the image may be altered to slide down an equivalent amount and if desired the scale of one or more regions of the video may be changed, with the additional strips or slivers then being moved onto display.

As understood herein, in some computer simulations such as computer games, the game may include an enemy or other object that shouldn't be visible at a particular time on screen so as not to spoil a future aspect of the game. In such a case, the metadata may also include information about such key or critical objects, such as dynamic placement in which the metadata accompanying the game can specify whether the object either can't be viewed or must be in view.

In addition to the techniques described above, machine learning may be used to generate additional image for the border regions of the video to be moved into view when the video is moved up or down or left or right as appropriate to compensate for motion. So-called “hole-filling” algorithms may be used, such that, for example, if only parts of an object appear in the original video, the machine learning algorithm can determine and generate unshown portions of the object to be moved into view as the video frame is shifted to compensate for camera motion.

As further understood herein, some “mask” portions of a video game may be moving and other mask portions not moving. To illustrate, if a video game emulates a race car driver from the perspective of the driver, a first view or “mask” from the helmet is part of the presentation, a second view or “mask” for the view out of the windshield is part of the presentation, and a third view or mask of objects outside the car is part of the presentation. In such a case, only the view outside the car might be depicted as moving, so only that view or “mask” must be motion-stabilized, while the first two masks need not be stabilized.

Thus, regions within regions with respective, and different, motion vectors for each region may be indicated in the metadata to indicate which “mask” must be stabilized. A simple bitmap may be used for each mask.

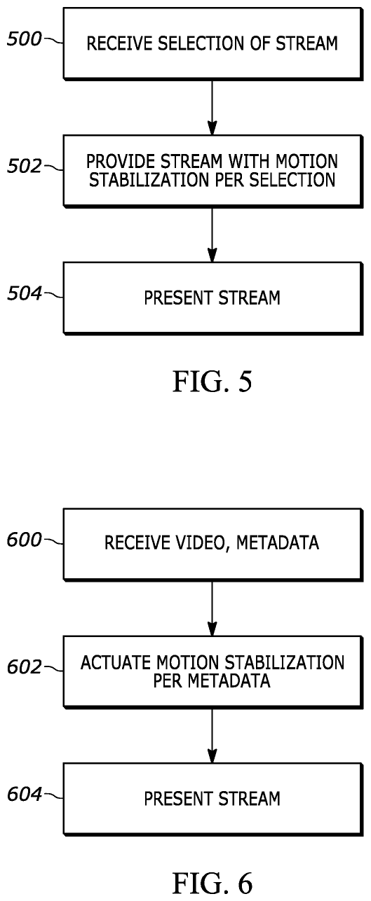

FIG. 5 illustrates logic consistent with FIG. 3 while FIG. 6 illustrates logic consistent with FIG. 4. Commencing at block 500 in FIG. 5, selection is received by the source 200 of the desired stream from the player system 202 via, for instance, the UI 300 in FIG. 3. Moving to block 502, the selected stream, motion stabilized or not motion stabilized, is sent from the source to the player system consistent with the selection at block 500. The stream is then presented on the display 302 at block 504.

In contrast, at block 600 in FIG. 6, the player system 202 receives a stream such as the stream 400 from the source 200 that may be configured as the normal stream 206 in FIG. 2. The user of the player system 202 can input motion stabilization preferences, such that at block 602 the player system 202 can access the metadata 400 that accompanies the stream 400 and apply digital motion stabilization according to the user references and the indications regarding camera motion in the metadata 400. The stream is then presented on the display 302 at block 604.

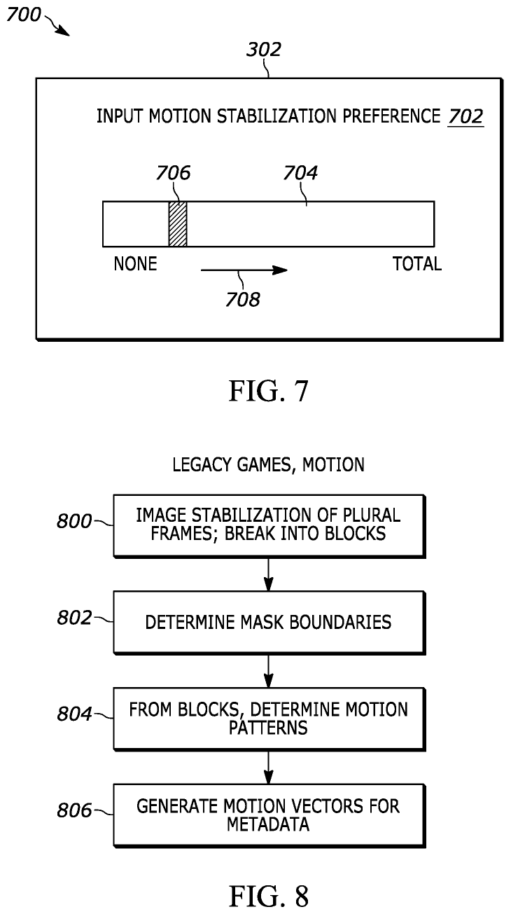

FIG. 7 illustrates an example UI 700 that may be presented on the display 302 of the player system 202 for inputting user preference with respect to motion stabilization. In the non-limiting example shown, the UI 700 includes a prompt 702 for the user to input his or her preference with respect to motion stabilization. A slide bar 704 may be presented with slider 706 that can be slide left and right as indicated by the arrow 708 to indicate an amount of desired motion stabilization, from none to total (as much stabilization as possible).

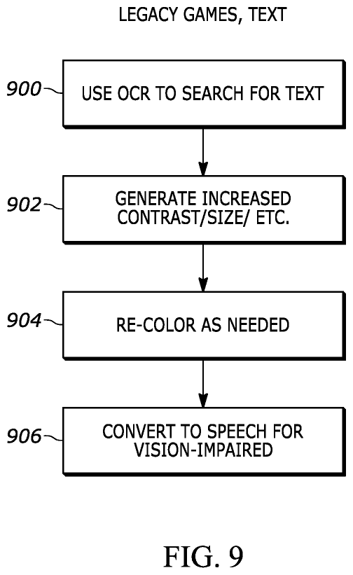

FIGS. 8 and 9 illustrate logic that may be executed to generate the above-described metadata in the case of legacy computer simulations that typically do not include metadata. Commencing at block 800, image stabilization is applied over a series of frames to generate motion angle and magnitude indicia. If desired the frames may be broken into smaller blocks with motion compensation executed on the individual blocks of each frame. Blocks with similar motion vectors may be merged together. Proceeding to block 802, refinement techniques are applied at the boundaries of blocks with different motion vectors to determine where the mask boundaries are, in cases of multiple masks as described above.

Proceeding to block 804, motion patterns are determined for all objects moving at the same direction and speed. For blocks at the boundary, the boundary blocks may be subdivided further, or an optimization algorithm imposed to determine the best solution. The motion vectors are generated at block 806 for metadata to accompany the legacy game based on the processing in blocks 800-804.

A machine learning model may be trained to learn and subsequently identify different masks in legacy games. The logic of FIG. 8 preferably may be done offline and executed over every frame since a better approximation may be obtained than if only a subset of frames is processed. The above technique also may be applied to non-legacy games.

A machine learning algorithm may be employed to implement the hole-filling mentioned previously for legacy games to generate the extra “border” content for the legacy games.

FIG. 9 illustrates that other accessibility information may be obtained for legacy games. Commencing at block 900, optical character recognition (OCR) may be executed on a legacy game to recognize text. Moving to block 902, the contrast and/or size of recognized text may be increased for easier viewing. If desired, the logic may move to block 904 to re-color the legacy game images as needed for color blind viewers or for creating more visible background colors for the color blind. If desired, the logic may move to block 906 to convert recognized text to speech for the vision-impaired or to re-render the text in a different language. In some embodiments 3D reconstruction may be implemented on the legacy game if that is needed for a disabled person.

The logic herein may be executed using any of the processors or combinations of processors herein. The metadata may be associated with the game engine, or from the viewer platform level or operating system (OS) level. The renderer of content may be the end user viewer system, a cloud server sourcing the simulation or video, or combinations thereof.

It will be appreciated that whilst present principals have been described with reference to some example embodiments, these are not intended to be limiting, and that various alternative arrangements may be used to implement the subject matter claimed herein.

What is claimed is:

1. A device, comprising:
at least one processor;
at least one computer memory that is not a transitory signal and that comprises instructions executable by the at least one processor to:
receive selection of one of two options, a first one of the options being motion stabilization of a first stream and a second one of the options being no motion stabilization of the first stream; and
provide the first stream to a viewer system according to the selection.

2. The device of claim 1, wherein two and only two options to provide to the viewer system are available.

3. The device of claim 1, wherein more than two options are available to provide to the viewer system, each option being characterized by a respective motion stabilization amount different from motion stabilization amounts of other options.

4. The device of claim 1, wherein the device is implemented by a stream source, and the device further comprises the viewer system.

5. The device of claim 4, wherein the viewer system is configured with instructions to present on a display a user interface (UI) comprising at least two selectors selectable to input the selection to the source.

6. The device of claim 1, wherein the stream provided to the player is stabilized in six degrees of freedom.

7. An apparatus, comprising:
at least one computer readable storage medium that is not a transitory signal, the at least one computer readable storage medium comprising instructions executable by at least one processor to:
receive at least one stream, the stream comprising at least video or at least a computer simulation or at least video and a computer simulation;
receive along with the stream metadata; and
present the stream with at least one accessibility feature according to the metadata.

8. The apparatus of claim 7, wherein the metadata comprises information pertaining to motion stabilization of the stream.

9. The apparatus of claim 7, wherein the metadata is contained in an auxiliary stream separate from the stream.

10. The apparatus of claim 7, wherein the metadata is contained in the stream.

11. The apparatus of claim 7, wherein the metadata comprises at least one vector that indicates motion of a camera.

12. The apparatus of claim 7, wherein the metadata comprises information pertaining to touch and sound features.

13. The apparatus of claim 7, wherein the metadata comprises information pertaining to re-coloring the stream.

14. The apparatus of claim 7, wherein the metadata comprises information pertaining to altering text in the stream.

15. A device, comprising:
at least one processor;
at least one computer memory that is not a transitory signal and that comprises instructions executable by the at least one processor to:
receive selection of one of two options, a first one of the options being at least one accessibility feature of a first stream and a second one of the options being no accessibility feature of the first stream; and
provide the first stream to a viewer system according to the selection.

16. The device of claim 15, wherein the instructions are executable to modify haptic sensations according to user preference.

17. The device of claim 15, wherein at least two options are available to provide to the viewer system, each option being characterized by a respective motion stabilization amount different from motion stabilization amounts of other options.

18. The device of claim 15, wherein the instructions are executable to present an image of at least one sound sources responsive to input indicating a hearing-impaired user.

19. The device of claim 15, wherein the accessibility feature comprises re-coloring of at least portions of the first stream.

20. The device of claim 15, wherein the accessibility feature comprises re-sizing of at least portions of the first stream.
